(19) United States
(12) Patent Application Publication
(10) Pub. No.: US 2003/0157414 A1
(43) Pub. Date: Aug. 21, 2003

(54) HOLOGRAPHIC MEDIUM AND PROCESS FOR USE THEREOF

(76) Inventors: PRADEEP K. DHAL, ACTON, MA (US); RICHARD T. INGWALL, NEWTON, MA (US); ERIC S. KOLB, IPSWICH, MA (US); HSIN YU LI, LEXINGTON, MA (US); DAVID A. WALDMAN, ACTON, MA (US)

Correspondence Address: POLAROID CORPORATION, PATENT DEPARTMENT, 1265 MAIN STREET, WALTHAM, MA, 02451, US

(21) Appl. No.: 08/970,066

(22) Filed: Nov. 13, 1997

(51) Int. Cl. G03H 1/04

(52) U.S. Cl. 430/1; 430/2; 430/280.1; 522/172

(57) ABSTRACT

A holographic recording medium showing little or no shrinkage after exposure comprises an acid generator capable of producing an acid upon exposure to actinic radiation; a binder; a difunctional epoxide monomer or oligomer; and a polyfunctional (i.e., tri- or higher functional) epoxide monomer or oligomer, the difunctional and polyfunctional epoxide monomers or oligomers being capable of undergoing cationic polymerization initiated by the acid produced from the acid generator. The medium is especially useful for holographic data storage applications.

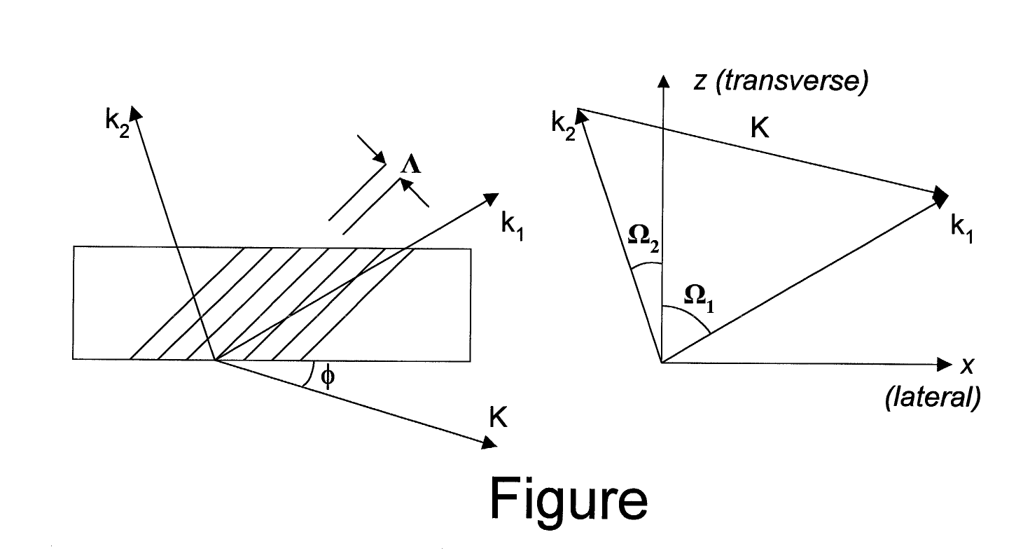

### REFERENCE TO RELATED APPLICATION

Attention is directed to copending application Ser. No. 08/743,419, filed Nov. 1, 1996 and assigned to the same assignee as the present application; this copending application describes and claims process for preparing a hologram, which process comprises:

providing a holographic recording medium comprising an acid generator which produces an acid upon exposure to actinic radiation; a binder; and at least one monomer or oligomer which undergoes cationic polymerization initiated by the acid produced from the acid generator, the holographic recording medium being essentially free from materials capable of free radical polymerization; and

passing into said medium a reference beam of coherent actinic radiation to which the acid generator is sensitive and an object beam of the same coherent actinic radiation, thereby forming within said medium an interference pattern, causing formation of the acid from the acid generator and cationic polymerization of said at least one monomer or oligomer, thereby forming a hologram within said medium.

### BACKGROUND OF THE INVENTION

This invention relates to a holographic recording medium and to a process for the use of this medium.

In prior art processes for the formation of volume-phase holograms, interference fringes are formed within a holographic recording medium comprising a homogeneous mixture of at least one polymerizable monomer or oligomer and a polymeric binder; the polymerizable monomer or oligomer must of course be sensitive or sensitized to the radiation used to form the interference fringes. In the illuminated regions of the fringes, the monomer or oligomer undergoes polymerization to form a polymer that has a refractive index different from that of the binder. Diffusion of the monomer or oligomer into the illuminated regions, with consequent chemical segregation of binder from these areas and its concentration in the non-illuminated regions, produces spatial separation between the polymer formed from the monomer or oligomer and the binder, thereby providing the refractive index modulation needed to form the hologram. Typically, after the holographic exposure, a post-imaging blanket exposure of the medium to actinic radiation is required to complete the polymerization of the monomer or oligomer and fix the hologram.

A known dry-process medium for holographic recording (sold commercially by E. I. du Pont de Nemours, Inc., Wilmington Del.) comprises a polymeric binder, a monomer capable of radical-initiated polymerization, and a photoinitiator (a term which is used herein to include polymerization initiators which are sensitive to radiation outside the visible range, for example ultra-violet radiation). Such a radical-polymerized medium suffers from a number of disadvantages, including severe inhibition of the radical polymerization by atmospheric oxygen, which requires precautions to exclude oxygen from the holographic medium. Also, radical polymerization often results in substantial shrinkage of the medium, with consequent distortion of the holographic image. Furthermore, radical polymerization often results in high intensity reciprocity failure, and it is difficult to record efficiently holograms having low spatial frequency components. The commercial du Pont medium may require a lengthy thermal post-exposure treatment to further develop the index modulation of the hologram, and this thermal treatment increases the shrinkage of the hologram and distorts the fringe pattern. Finally, the du Pont medium suffers from optical inhomogeneities which impair the signal-to-noise ratio of the material, and its semisolid properties tend to result in variations in coating thickness.

One important potential use for volume holograms is in digital data storage; the three dimensional nature of a volume hologram, coupled with the high information density and parallel read/write capability which can be achieved, renders volume holograms very suitable for use in high capacity digital data storage; in theory, compact devices having storage capacities in the terabyte (10¹² byte) range should readily be achievable. However, the aforementioned disadvantages of radical-polymerized holographic media, especially the lengthy thermal treatment, which are particularly serious when the media are to be used for digital data storage, have hitherto hindered the development of holographic data storage devices.

As already mentioned, copending application Ser. No. 08/743,419 describes holographic recording media which rely upon cationic polymerization without requiring free radical polymerization, thereby eliminating the aforementioned problems of media which use free radical polymerization. However, another important consideration in holographic recording media for digital data storage is the shrinkage of the medium during exposure. Volume phase holograms of digital data (recorded using a transparency or addressable spatial light modulator, optionally in conjunction with a randomized phase mask; see for example F. M. Smits and L. E. Gallagher, Design considerations for a semipermanent optical memory, Bell Syst. Tech. J., 46, 1267 (1967), C. B. Burckhardt and E. T. Doherty, Appl. Opt., 8, 2479 (1969), L. d'Auria, J. P. Huignard, C. Slezak, and E. Spitz, Experimental holographic read-write memory using 3-D storage, Appl. Opt., 13(4), 808 (1974), and F. H. Mok, Angle-multiplexed storage of 5000 holograms in lithium niobate, Opt. Lett., 18(11), 915 (1993)) are arranged in pages, and consist of a range of grating slant angles, each angle being formed from interference of the distinct spatial frequency components of the signal beam with the reference beam. Encoding schemes such as the use of paraphase coding, data coding based upon a randomized arrangement of binary digits, and representation of data in Hamming, Reed-Solomon, and channel codes, increase the reliability of volume holographic data storage by minimizing the effect of non-uniformities in diffraction efficiency, but although error correction codes reduce the impact of various noise contributions, they inherently involve some reduction in storage capacity. Accordingly, in designing holographic recording materials for use in digital data storage, it is important to minimize physical material contributions to noise, such as that arising from volume shrinkage of the medium during imaging.

The slant angles of volume phase holograms recorded in photo-polymers are altered by anisotropic volume shrinkage, which is attributed to the increase in density occurring during the photopolymerization reactions. This shrinkage causes angular deviations in the Bragg profile which can exceed the angular bandwidth, even for moderate slant angles. For example, a volume phase plane-wave transmission hologram, with thickness of about 100 μm, and recorded with non-slant geometry, exhibits an angular profile with a Bragg peak having a full width at half height of about 0.47°. If the recording medium only undergoes shrinkage in the transverse (thickness) direction then no shift occurs in the Bragg peak angle for a non-slant hologram. For slant-fringe transmission holograms, however, shifts in the Bragg peak angle are observed due to shrinkage, regardless of shrinkage direction. The magnitude of the angle shift is dependent on the slant angle and the amount of shrinkage. The du Pont photopolymer film, HRF-150-38, exhibits a Bragg angle shift of about 2.5° for a hologram with a moderate slant angle φ of 18°; see U.-S. Rhee, H. J. Caulfield, C. S. Vikram, and J. Shamir, Dynamics of hologram recording in du Pont photopolymer, Appl. Opt., 34(5), 846 (1995). For a hologram of 100 μm thickness with this slant angle, the full width at half height of the Bragg peak is about 0.7° for a read beam angle 12.5° from the direction normal to the surface. For a hologram of 200 μm thickness the full width at half height is one half of the value for a hologram of 100 μm thickness. Image reconstruction (readout) of a single image, which comprises multiple gratings, is therefore likely to result in lack of image fidelity and/or distortion, unless the shrinkage is reduced to extremely low levels.

We have now discovered that holographic recording media based upon a mixture of epoxide monomers of differing functionality record with reduced shrinkage, rendering these media especially suitable for use in digital data storage applications. These recording media also have lower threshold exposure energy requirements, thus allowing increased writing speed in data storage applications.

### SUMMARY OF THE INVENTION

Accordingly, this invention provides a process for preparing a hologram, which process comprises:

providing a holographic recording medium comprising an acid generator capable of producing an acid upon exposure to actinic radiation; a binder; a difunctional epoxide monomer or oligomer; and a polyfunctional epoxide monomer or oligomer, the difunctional and polyfunctional epoxide monomers or oligomers being capable of undergoing cationic polymerization initiated by the acid produced from the acid generator; and

passing into the medium a reference beam of coherent actinic radiation to which the acid generator is sensitive and an object beam of the same coherent actinic radiation, thereby forming within the medium an interference pattern and thereby forming a hologram within the medium.

The term “polyfunctional” is used herein in accordance with conventional usage in the chemical arts to mean a material in which each molecule has at least three groups of the specified functionality, in the present case at least three epoxy groups.

This invention also provides a holographic recording medium comprising an acid generator capable of producing an acid upon exposure to actinic radiation; a binder; a difunctional epoxide monomer or oligomer; and a polyfunctional epoxide monomer or oligomer, the difunctional and polyfunctional epoxide monomers or oligomers being capable of undergoing cationic polymerization initiated by the acid produced from the acid generator.

### BRIEF DESCRIPTION OF THE DRAWING

The accompanying drawing shows schematically the grating vector components in the xz-plane of a hologram of the present invention, as discussed in Example 4 below.

### DETAILED DESCRIPTION OF THE INVENTION

As already mentioned, the holographic recording medium of the present invention uses as its polymerizable components a difunctional epoxide monomer or oligomer, and a polyfunctional epoxide monomer or oligomer. For convenience and brevity, the description below will normally refer only to monomers, although it should be understood that oligomers can be substituted for the monomers if desired. Similarly, although the invention will mainly be described herein assuming that only one difunctional monomer and one polyfunctional monomer is present in the holographic recording medium, mixtures of more than one of each type of monomer may be used if desired, as may more than one binder. Finally, it should be noted that in both the difunctional and the polyfunctional monomers, the various epoxy functions need not all be the same.

It is preferred that at least one, and preferably both, of the difunctional and polyfunctional epoxide monomers used in the present invention be siloxanes, since siloxanes are generally compounds stable on prolonged storage but capable of undergoing rapid and well-understood cationic polymerization. The preferred type of epoxy group in both monomers is a cycloalkene oxide group, especially a cyclohexene oxide group, since the reagents needed to prepare this type of grouping are readily available commercially and are inexpensive. A particularly preferred group of difunctional monomers are those in which two cyclohexene oxide groupings are linked to an Si—O—Si grouping; these monomers have the advantage of being compatible with polysiloxane binders. Examples of such monomers include those of the formula:

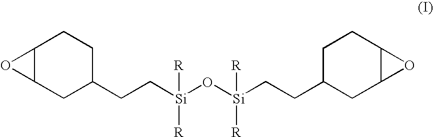

where each R independently is an alkyl group containing not more than about 6 carbon atoms. The compound in which each group R is a methyl group is available from Polyset Corporation, Inc., Mechanicsville, N.Y., under the tradename PC-1000, and the preparation of this specific compound is described in, inter alia, U.S. Pat. Nos. 5,387,698 and 5,442,026.

A variety of tri-, tetra- and higher polyepoxysiloxanes have been found useful as the polyfunctional monomer in the present medium and process. One group of such polyepoxysiloxanes are the cyclic compounds of the formula:

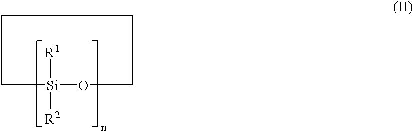

wherein each group R¹ is, independently, a monovalent substituted or unsubstituted C₁₋₁₂ alkyl, C₁₋₁₂ cycloalkyl, aralkyl or aryl group; each group R² is, independently, R¹ or a monovalent epoxy functional group having 2-10 carbon atoms, with the proviso that at least three of the groups R² are epoxy functional; and n is from 3-10. The preparation of these cyclic compounds is described in, inter alia, U.S. Pat. Nos. 5,037,861; 5,260,399; 5,387,698; and 5,583,194. One specific useful polymer of this type is 1,3,5,7-tetrakis(2-(3,4-epoxycyclohexyl)ethyl)-1,3,5,7-tetramethylcyclotetrasiloxane.

The preferred polyfunctional epoxide monomers are those of the formula:

R³Si(OSi(R⁴)₂R⁵)₃ (III)

R³ is an OSi(R⁴)₂R⁵ grouping, or a monovalent substituted or unsubstituted C₁₋₁₂ alkyl, C₁₋₁₂ cycloalkyl, aralkyl or aryl group; each group R⁴ is, independently, a monovalent substituted or unsubstituted C₁₋₁₂ alkyl, C₁₋₁₂ cycloalkyl, aralkyl or aryl group; and each group R⁵ is, independently, a monovalent epoxy functional group having 2-10 carbon atoms; this type of monomer may hereinafter be called a “star type” monomer. The preparation of these monomers is described in, inter alia, U.S. Pat. Nos. 5,169,962; 5,260,399; 5,387,698; and 5,442,026. One specific monomer of this type found useful in the present process is that in which R³ is a methyl group or an OSi(R⁴)₂R⁵ grouping; each group R⁴ is a methyl group, and each group R⁵ is a 2-(3,4-epoxycyclohexyl)ethyl grouping.

A second preferred group of polyfunctional monomers for use in the present medium and process are those of the formula:

(R⁶)₃SiO[SiR⁷R⁸O]ₚ[Si(R⁷)₂O]_{q}Si(R⁶)₃ (IV)

each group R⁶ is, independently, a monovalent substituted or unsubstituted C₁₋₁₂ alkyl, C₁₋₁₂ cycloalkyl, or phenyl group; each group R⁷ is, independently, a monovalent substituted or unsubstituted C₁₋₁₂ alkyl, C₁₋₁₂ cycloalkyl, aralkyl or aryl group; each group R⁸ is, independently, a monovalent epoxy functional group having 2-10 carbon atoms, and p and q are integers. These monomers may be prepared by processes analogous to those described in U.S. Pat. No. 5,523,374, which involve hydrosilylation of the corresponding hydrosilanes with the appropriate alkene oxide using a platinum or rhodium catalyst. Specific monomers of this type found useful in the present process are those in which each group R⁶ and R⁷ is an alkyl group, and of these one especially preferred monomer is that in which R⁸ is an 2-(3,4-epoxycyclohexyl)ethyl grouping and p and q are approximately equal.

The binder used in the present medium and process should of course be chosen such that it does not inhibit cationic polymerization of the monomers used, and such that its refractive index is significantly different from that of the polymerized monomer or oligomer. Preferred binders for use in the present process are polysiloxanes and polystyrenes. Because of the wide variety of polysiloxanes available and the well-documented properties of these polymers, the physical, optical and chemical properties of the polysiloxane binder can all be adjusted for optimum performance in the recording medium.

The efficiency of the holograms produced by the present process is markedly dependent upon the particular binder employed. Although those skilled in the holographic art will have no difficulty in selecting an appropriate binder by routine empirical tests, in general it may be stated that poly(methyl phenyl siloxanes) and oligomers thereof, such as the trimer sold by Dow Chemical Company under the trade name Dow 705, have been found to give efficient holograms.

The acid generator used in the present recording medium produces an acid upon exposure to the actinic radiation. The term “acid generator” is used herein to refer to the component or components of the medium that are responsible for the radiation-induced formation of acid. Thus, the acid generator may comprise only a single compound that produces acid directly. Alternatively, the acid generator may comprise an acid generating component which generates acid and one or more sensitizers which render the acid generating component sensitive to a particular wavelength of actinic radiation, as discussed in more detail below The acid produced from the acid generator may be either a Bronstead acid or a Lewis acid, provided of course that the acid is of a type and strength which will induce the cationic polymerization of the monomer. When the acid generator produces a Bronstead acid, this acid preferably has a pKₐ less than about 0. Known superacid precursors such as diazonium, sulfonium, phosphonium and iodonium salts may be used in the present medium, but iodonium salts are generally preferred. Diaryliodonium salts have been found to perform well in the present media, with specific preferred diaryliodonium salts being (4-octyloxyphenyl)phenyliodonium hexafluoroantimonate and ditolyliodonium tetrakis(pentafluorophenyl)borate. Among the Lewis acid generators, ferrocenium salts have been found to give good results in the present media, a specific preferred ferrocenium salt being cyclopentadienyl cumene iron(II) hexafluoro-phosphate, available commercially under the tradename Irgacure 261 from Ciba-Geigy Corporation, 7 Skyline Drive, Hawthorne N.Y. 10532-2188. This material has the advantage of being sensitive to 476 or 488 nm visible radiation without any sensitizer, and can be sensitized to other visible wavelengths as described below.

In the absence of any sensitizer, iodonium salts are typically only sensitive to radiation in the far ultra-violet region, below about 300 nm, and the use of far ultra-violet radiation is inconvenient for the production of holograms because for a given level of performance ultra-violet lasers are substantially more expensive than visible lasers. However, it is well known that, by the addition of various sensitizers, iodonium salts can be made sensitive to various wavelengths of actinic radiation to which the salts are not substantially sensitive in the absence of the sensitizer. In particular, iodonium salts can be sensitized to visible radiation with sensitizers using certain aromatic hydrocarbons substituted with at least two alkynyl groups, a specific preferred sensitizer of this type being 5,12-bis(phenylethynyl)naphthacene. This sensitizer renders iodonium salts sensitive to the 514 nm radiation from an argon ion laser, and to the 532 nm radiation from a frequency-doubled YAG laser, both of which are convenient sources for the production of holograms.

This preferred sensitizer also sensitizes ferrocenium salts to the same wavelengths, and has the advantage that it is photobleachable, so that the visible absorption of the holographic medium decreases during the exposure, thus helping to produce a low minimum optical density (Dₘᵢₙ) in the hologram.

The proportions of acid generator, binder and monomers in the holographic recording medium of the present invention may vary rather widely, and the optimum proportions for specific components and methods of use can readily be determined empirically by skilled workers. However, in general, it is preferred that the present medium comprise from about 0.2 to about 5 parts by weight of the difunctional epoxide monomer per part by weight of the polyfunctional epoxide monomer, and it also preferred that the medium comprise from about 0.16 to about 5 parts by weight of the binder per total part by weight of the difunctional epoxide monomer and the polyfunctional epoxide monomer.

For reasons already explained above, it is desirable that the components of the holographic recording medium of the present invention be chosen so that the volume shrinkage of the medium be kept as small as possible; this shrinkage desirably does not exceed about 1 per cent.

The following Examples are now given, though by way of illustration only, to show details of particularly preferred reagents, conditions and techniques used in preferred media and processes of the present invention.

### EXAMPLE 1

A series of holographic recording media was prepared comprising (4-octyloxyphenyl)phenyliodonium hexafluoroantimonate (an acid generator), 5,12-bis-(phenylethynyl)naphthacene (hereinafter called “BPEN”; this material sensitizes the iodonium salt to green visible radiation), and, as a binder, poly(methyl phenyl siloxane), refractive index 1.5365, available from Dow Chemical Company, Midland, Mich., under the tradename Dow 710 silicone fluid. The media further comprised the difunctional epoxide monomer of Formula I above in which each group R is methyl, and either the tetrafunctional monomer 1,3,5,7-tetrakis(2-(3,4-epoxycyclohexyl)ethyl)-1,3,5,7-tetramethylcyclotetrasiloxane, or the trifunctional monomer of Formula III above in which R³ is a methyl group; each group R⁴ is a methyl group, and each group R⁵ is a 2-(3,4-epoxycyclohexyl)ethyl grouping. The exact compositions of the media formulated, and the mole ratios of difunctional to polyfunctional monomer therein are set forth in Table 1 below.

Each holographic recording medium was prepared by first adding the specified weight of the difunctional epoxide to a sufficient amount of the iodonium salt to make the content of the iodonium salt in the final recording medium 4.8 percent by weight. Dissolution of the iodonium salt occurred upon stirring. The specified weight of the tri- or tetrafunctional monomer was then added and the mixture was stirred until a uniform mixture was obtained. The Dow 710 binder was added to the resultant mixture, and a uniform mixture was obtained after stirring. Finally, a sufficient amount of the BPEN sensitizer, dissolved in approximately 300 μL of methylene chloride, was added to the mixture to form a final mixture containing 0.048% by weight of the sensitizer. This final mixture was stirred and the methylene chloride removed by purging the medium with argon gas, to form the holographic recording medium, which had the form of a solution.

TABLE 1

| | |
|---|---|
| Component | Weight (mg) |

| | | | | |
|---|---|---|---|---|
| Difunctional monomer | 150 | 225 | 306 | 460 |
| Tetrafunctional monomer | — | — | 340 | 266 |
| Trifunctional monomer | 150 | 75 | — | — |
| Binder | 100 | 100 | 162 | 162 |
| Iodonium salt | 20 | 20 | 40 | 40 |
| Sensitizer | 0.2 | 0.2 | 0.4 | 0.4 |
| Mole ratio (di:poly) | 63:37 | 83:17 | 63:37 | 77:23 |

To test the holographic recording characteristics of these media, a sample of each medium was placed between two glass slides separated by a 100 μm polytetrafluoroethylene spacer. Unslanted, plane-wave, transmission holograms were recorded in the conventional manner with two spatially filtered and collimated argon ion laser writing beams at 514.5 nm with equal irradiance levels (±2%) directed onto the sample with equal semiangles of 25° about the normal. Since these media are not sensitive to red light, a beam-expanded helium neon laser probe beam (λ=632.8 nm), incident at the appropriate Bragg angle, was used to detect the development of holographic activity during exposure. Real time diffraction intensity data was obtained before, during and after holographic exposure using two model 818-SL photodiodes and a dual channel multi-function optical meter Model 2835-C from Newport Corporation. The zeroth order and first order diffraction intensities from the grating were measured, and the holographic efficiency determined.

Samples containing the tetrafunctional monomer were imaged with a total holographic exposure fluence of 93 mJ/cm², using two 5 second exposures separated by a wait time of 25 seconds. Threshold energies (defined as the fluence necessary for observation of a stable diffraction efficiency of about 0.1%), were approximately 18.9 and 20.5 mJ/cm² for the 77:23 and 63:37 mole ratio media, respectively. High diffraction efficiency was attained and the hologram was stable without post-imaging exposure.

Samples containing the trifunctional monomer were imaged with a holographic exposure fluence of either 75 mJ/cm² or 47 mJ/cm² (for the 83:17 medium) using a continuous 8 or 5 second exposure, and 75 mJ/cm² (for the 63:37 medium) using a continuous 8 second exposure. Threshold energies for the 83:17 and 63:37 mole ratio media were approximately 21 and 33 mJ/cm², respectively. High diffraction efficiency was attained and the hologram was stable without post-imaging exposure.

### EXAMPLE 2

A series of holographic recording media was prepared comprising the same acid generator, sensitizer, binder and difunctional epoxide monomer as in Example 1 above. However, the polyfunctional monomer used was the tetrafunctional monomer of Formula III above in which R³ is an OSi(CH₃)₂-2-(3,4-epoxycyclohexyl)ethyl grouping; each group R⁴ is a methyl group, and each group R⁵ is a 2-(3,4-epoxycyclohexyl)ethyl grouping. The exact compositions of the media formulated, and the mole ratios of difunctional to polyfunctional monomer therein are set forth in Table 2 below. The media were formulated in the same manner as in Example 1 above.

TABLE 2

| Component | Weight (mg) | | | | |
|---|---|---|---|---|---|
| Difunctional monomer | 321.3 | 460 | 306 | 192 | 197.6 |
| Tetrafunctional monomer | 132 | 297 | 360 | 412 | 833.7 |
| Binder | 114 | 190 | 167 | 152 | 260.8 |
| Iodonium salt | 28 | 47 | 41 | 38 | 67.5 |
| Sensitizer | 0.28 | 0.47 | 0.42 | 0.4 | 0.8 |
| Mole ratio (di:poly) | 84:16 | 77:23 | 64:36 | 50:50 | 33:67 |

The imaging properties of these media were tested in the same manner as in Example 1 above, using a fluence of 93.3 mJ/cm². Two different exposure schedules were used, namely a continuous 10 second exposure and two 5 second exposures separated by a 30 second wait period. The lowest threshold energies recorded under these conditions were 34.2, 30.1, 32.2, 17.4 and 26.1 mJ/cm² for the 84:16, 77:23, 64:36, 50:50 and 33:66 formulations respectively.

The threshold energy for the 64:36 medium was in fact lower than recorded above due to a misalignment of the HeNe probe beam. High diffraction efficiency was attained (circa 90%) for holograms recorded in media of each composition, and the holograms were stable without post-imaging exposure. A sample of the 50:50 mole ratio formulation with the contents of iodonium salt and sensitizer increased to 6.1% and 0.1%, respectively, exhibited a decrease in threshold energy to less than about 9 mJ/cm² and an increase in sensitivity by a factor of about 2.4.

### EXAMPLE 3

A holographic recording medium was prepared comprising the same acid generator, sensitizer, and difunctional epoxide monomer as in Example 1 above. The medium also comprised a polyfunctional epoxide monomer of Formula IV above, this monomer being of the formula:

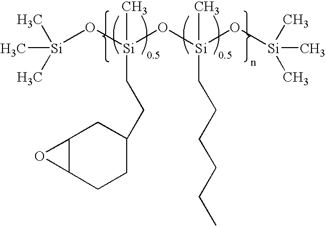

and, as a binder, 1,3,5-trimethyl-1,1,3,5,5-pentaphenyltrisiloxane (refractive index 1.579, available from Dow Chemical Company, Midland, Mich., under the tradename Dow 705 silicone fluid). The medium contained 4.6 weight percent of the iodonium salt, 0.09 weight percent of the sensitizer and the monomer to binder mole ratio (based upon segmental values for the polyfunctional monomer) was 2.78. The medium was prepared in the same manner as in Example 1 above.

Samples of this medium were imaged in the same way as in Example 1 with a holographic exposure fluence of either 28 mJ/cm² or 18.7 mJ/cm² using a continuous 3 or 2 second exposure, respectively. Threshold energies were only about 1.5 mJ/cm² and the sensitivity was approximately four times as high as that of the media described in Example 2, for the same iodonium salt concentration. High diffraction efficiency was attained and the hologram was stable without post-imaging exposure.

### EXAMPLE 4

This Example illustrates the low shrinkage which can be achieved during imaging of holographic recording media of the present invention.

A holographic recording medium was prepared comprising the same difunctional epoxide monomer and sensitizer as in Example 1 above, and the tetrafunctional monomer of the formula:

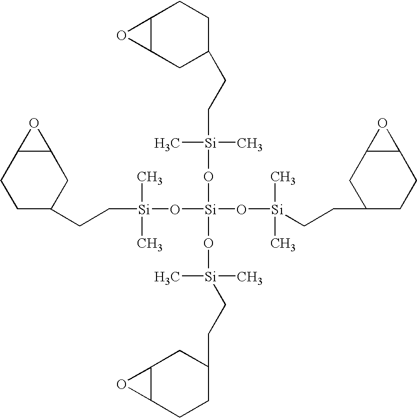

which falls within Formula III above. The ratio of epoxy groups in the difunctional and tetrafunctional monomers was 0.73. The binder used was, the same as that in Example 3 above, and the equivalent monomer to binder segmental based weight ratio was 68.0:32.0. The iodonium salt used was bis(methylphenyl)iodonium tetrakis(pentafluorophenyl)borate (obtained from Rhone Poulenc as Silcolease UV Cata Poudre (Registered Trade Mark) 200 and purified by recrystallization from methylene chloride:hexane and dried before use). The holographic medium was prepared in the same manner as in Example 1 above and contained 7.0 weight percent of the iodonium salt, and 0.036 weight percent of the sensitizer.

Slant fringe plane-wave, transmission holograms were recorded with a frequency doubled Nd:YAG laser at 532 nm using two spatially filtered and collimated laser writing beams directed onto a sample of this medium with an interbeam angle of 34° 10°. The intensities of the two beams were adjusted to compensate for relative angle cosine factors. The sample was mounted onto a motorized rotation stage, Model 495 from Newport Corporation. The rotational position of the stage, and thus the angle of the sample plane relative to the writing beams, was computer controlled via a motion controller Model PMC200P from Newport Corporation. Accordingly, during the holographic exposures the interbeam angle of the signal and reference beam paths remained fixed, while the sample of the holographic recording medium was rotated to alter the grating angle of the resultant slant fringe hologram.

Angular selectivity measurements were performed using spatially filtered and collimated laser reading beams from a frequency doubled Nd:YAG laser at 532 nm with incident power of about 20 μW. The sample was mounted on a motorized rotation stage, as during recording, and thus the angle of the sample plane relative to either the reference or signal beam was computer controlled via a motion controller Model PMC200P from Newport Corporation. The read angle was detuned from the recording state while maintaining the sample in its original mount position, and the diffraction efficiency was measured at each angular increment with photodiodes and an optical meter from Newport Corporation (see above). The angular resolution was 0.001° and the experimentally determined repeatability was ≦0.005°, which was attained by use of unidirectional rotation during measurement thereby eliminating any effect from backlash of the compliant worm gear. Accordingly, for these measurements the signal and reference beam paths remain fixed with an interbeam angle of 34° 10′, while the surface plane of the volume hologram was rotated to alter the incident angle of the signal and reference read beam paths. Measurement of angular selectivity was carried out independently for the signal and reference beams, along beam paths 1-2′ (Readout 2′) and 2-1′ (Readout 1′), respectively, by rotation of the hologram over a range of plus or minus several degrees from the recording position at increments of 0.001°≦Δθ≦0.02°. In this manner, during reconstruction of the volume hologram, angular deviations from the recording condition necessary to achieve Bragg matching, ΔΩ₁ and ΔΩ₂ (see the accompanying drawing), were obtained explicitly for the signal and reference beams for each slant fringe construction.

The grating vector components along the transverse (z-axis) and lateral directions (x-axis), K_{z,i} and K_{x,i}, respectively, at the initial state of recording, can be expressed in terms of the average refractive index, n, of the recording medium, and the external signal and reference write beam angles, Ω₁_{ₑₓₜ} and Ω₂_{ₑₓₜ}, respectively, used during holographic recording as

$$\begin{matrix}{K}_{z , i} = \frac{2 π}{λ} ( \sqrt{{n}^{2} - {sin}^{2} {Ω}_{{1}_{ext}}} - \sqrt{{n}^{2} - {sin}^{2} {Ω}_{{2}_{ext}}} ) & ( 1 ) \\ {K}_{x , i} = \frac{2 π}{λ} ( sin {Ω}_{{1}_{ext}} + sin {Ω}_{{2}_{ext}} ) & ( 2 )\end{matrix}$$

The incremental changes in the grating vector components along the transverse and lateral directions, ΔK_{z} and ΔKₓ, respectively, that arise due to shrinkage, can be expressed in terms of measurable quantities as

$$\begin{matrix}Δ {K}_{z} = \frac{2 π}{λ} ( \frac{sin {Ω}_{{2}_{ext}} cos {Ω}_{{2}_{ext}}}{\sqrt{{n}^{2} - {sin}^{2} {Ω}_{{2}_{ext}}}} {ΔΩ}_{{2}_{ext}} - \frac{sin {Ω}_{{1}_{ext}} cos {Ω}_{{1}_{ext}}}{\sqrt{{n}^{2} - {sin}^{2} {Ω}_{{1}_{ext}}}} {ΔΩ}_{{1}_{ext}} ) + \frac{2 π}{λ} ( \frac{Δ n}{n} ) ( \frac{{n}^{2}}{\sqrt{{n}^{2} - {sin}^{2} {Ω}_{{1}_{ext}}}} - \frac{{n}^{2}}{\sqrt{{n}^{2} {sin}^{2} {Ω}_{{2}_{ext}}}} ) \\ and & ( 3 ) \\ Δ {K}_{x} = \frac{2 π}{λ} ( cos {Ω}_{{1}_{ext}} Δ {Ω}_{{1}_{ext}} + cos {Ω}_{{2}_{ext}} {ΔΩ}_{{2}_{ext}} ) & ( 4 )\end{matrix}$$

where ΔΩ₁_{ₑₓₜ} and ΔΩ₂_{ₑₓₜ} are the respective angular deviations from the Bragg matching condition of the two write beams, and Δn is the change in refractive index that occurs during recording.

The change in internal slant angle, Δφ, can be expressed in terms of the initial lateral and transverse grating components, K_{x,i} and K_{z,i}, and the respective changes, ΔKₓ and ΔK_{z}, as

$${Δφ}_{slant} = \frac{( {K}_{x , i} Δ {K}_{z} - {K}_{z , i} Δ {K}_{x} )}{( {K}_{x , i}^{2} + {K}_{z , i}^{2} )} \qquad ( 5 )$$

where during shrinkage the grating period component, Λₓ, is not assumed to be fixed as the grating slant angle rotates to increased angle, contrary to the boundary conditions of the fringe rotation model. The relative changes in the transverse (perpendicular to film plane) and lateral (parallel to film plane) components of the grating vector, −ΔK_{z}/K_{z,i} and −ΔKₓ/K_{x,i}, respectively, are equal to the physical material shrinkage along the respective directions independent of slant angle, φ. Referring to the accompanying drawing and assuming uniaxial shrinkage, the grating period in the transverse direction, Λ_{z}, are before and after recording

$$\begin{matrix}{Λ}_{z , i} = \frac{{Λ}_{i}}{cos {φ}_{i}} & ( 6 ) \\ {Λ}_{z , f} = \frac{{Λ}_{i}}{cos {φ}_{f}} & ( 7 )\end{matrix}$$

where K_{z}=2π/Λ_{z} and ΔK_{z}/K_{z}=−ΔΛ_{z}/Λ_{z}. Generally, regardless of whether or not the shrinkage is uniaxial ΔKₓ/Kₓ=−ΔΛₓ/Λₓ. Clearly ΔK/Kᵢ varies, depending upon the slant angle, but, although the magnitude ΔK/Kᵢ directly represents the amount of dimensional change along the grating vector direction, it does not provide directional information and contains no contribution from the lateral y direction. To assess the relative volume change, ΔV/V, during recording requires an assumption of homogeneity in the lateral directions (i.e. Δx/x=Δy/y) which is reasonable for volume hologram formation in photopolymers, considering that the final recorded state is a glassy material. The relative volume shrinkage can thus be expressed as

$$\frac{Δ V}{V} = - ( \frac{Δ {K}_{z}}{{K}_{z , i}} + \frac{2 Δ {K}_{x}}{{K}_{x , i}} ) \\ 1. Angular shifts \qquad ( 8 )$$

The magnitude of dimensional change in the grating period along the x (lateral) and z (transverse) directions, −ΔKₓ/K_{x,i} and −ΔK_{z}/K_{z,i}, that occurs during hologram formation was calculated explicitly from the shift in the grating vector components using Equations. 3, 4, 6, and 7 above by (1) measuring the deviation of the Bragg angle from the external signal and reference beam write angles, ΔΩ₁_{ₑₓₜ} and ΔΩ₂_{ₑₓₜ}, respectively; and (2) determining the change in the average refractive index, n, of the holographic recording medium. The former was obtained by directly measuring the differential angle changes in the reference and signal beam angles, necessary to achieve Bragg matching, by rotation of the sample (i.e. the recording geometry is not altered). The latter was measured to within 2×10⁻⁴ using a Bausch & Lomb Refractometer. Since the bond order does not change during Cationic Ring Opening Polymerization, the increase in refractive index that results during exposure of the recording medium is due predominantly to densification of the material.

The results are presented in Tables 3 and 4 for slant fringe plane-wave holograms recorded to near saturation (diffraction efficiency 90%) in the recording medium of this Example. Counterclockwise rotations of the sample plane, for slant fringe holograms with internal grating angles of φ=5°, were required to Bragg match Ω₁_{ₑₓₜ} and Ω₂_{ₑₓₜ} immediately after recording. The differential angle changes, ΔΩ₁_{ₑₓₜ} and ΔΩ₂_{ₑₓₜ}, were thus negative (−) and positive (+), respectively, regardless of whether the signal and reference beam recording angles are in the same or different quadrants. The requisite counterclockwise rotation increased slightly during the wait time necessary to attain stable plateau values. Accordingly the final signs of ΔΩ₁_{ₑₓₜ} and ΔΩ₂_{ₑₓₜ} for φ=5° were (−) and (+), respectively, which indicates that the grating slant angle increased and the grating period decreased.

Table 3 are listed measured values of Ω₁_{ₑₓₜ}, Ω₂_{ₑₓₜ}, ΔΩ₁_{ₑₓₜ}, and ΔΩ₂_{ₑₓₜ} and the corresponding internal grating slant angles at the onset of recording, φₒ, the initial state at which stable diffraction efficiency is first observed, φᵢ, and the final physical state of the holographic recording medium, φ_{f}. The values of ΔΩ₁_{ₑₓₜ} and ΔΩ₂_{ₑₓₜ} listed are the final shifts (plateau values) observed for individual holograms recorded with grating slant angle between about 0.03° and 30°. At the onset of recording the material is a fluid, whereas when stable grating formation first occurs the material is in a pre-gelatinous state, and after recording and achieving the fall extent of cure the material is in a glassy state. Accordingly, the initial value of the refractive index, used in Table 3 and for calculations of ΔKₓ/K_{x,i} and ΔK_{z}/K_{z,i} listed in Table 4, was ascertained from measurement of the recording medium after an imaging exposure equivalent to the requisite fluence for observation of stable diffraction efficiency (i.e. η˜0.25%). The physical state of the recording medium after such an exposure comprises sufficient microstructural integrity to manifest a stable fringe structure with defined spatial frequency. This exposure exceeds the threshold exposure fluence, defined here as the fluence necessary to first detect holographic activity, by a few mJ/cm². For purposes of calculating the physical material shrinkage, ΔV/V, this method provides a more equitable estimate of the initial refractive index during hologram formation, when recording to near saturation, than would values at the onset of recording. Use of the former will probably result in a conservative estimate of the physical material shrinkage, whereas employing the latter could effect a consequential underestimate of ΔK_{z}/K_{z,i} (ΔKₓ/K_{x,i} is independent of Δn) if a significant change in refractive index occurs during early stages of hologram formation. The final value of the refractive index used in Tables 3 and 4 corresponds to that measured after the photopolymer recording medium was exposed with a non-holographic fluence commensurate with that needed to consume the entire dynamic range.

The magnitude of the angular deviations listed in Table 3 are about one fifth of that reported recently for a slant fringe hologram recorded with similar grating angle in a conventional photopolymer based on radical chemistry; see the aforementioned Rhee et al. paper. As noted above, modest levels of shrinkage, attributed to densification concurrent with photopolymerization, have typically caused angular deviations in the Bragg profile which can exceed the angular bandwidth, even for moderate slant angles. The angular shifts exhibited by the recording medium of this Example, however, are less than the angular bandwidths of the angular profiles for holograms with internal grating slant angles ≦30°, and with a thickness of about 130 μm. These results also indicate that when volume holograms are recorded with increasing grating slant angle then a concomitant increase is exhibited in their respective angular shifts from the Bragg matching condition. This increase is consistent with contributions to physical shrinkage that arise from the relation between increased slant angle and larger transverse components of the grating vector, as is apparent from Equation 5 above. The magnitude of the relative differences in angular shifts as a function of grating slant angle is an important performance criterion in considering holographic materials for applications such as optical data storage. For example, if the differences are large for a single image which comprises multiple gratings, such as for a Fourier image, then image reconstruction will display lack of image fidelity and consequently distortion, thereby impairing the achievable raw error bit rate.

TABLE 3
Measured external angles and deviations of recording external
angles from the Bragg matching condition, and calculated internal
grating slant angles for plane-wave slant fringe holograms
recorded to near saturation

| Slant fringe | | | | |
|---|---|---|---|---|
| holograms* | 5° | 10° | 20° | 30° |

External angles and Bragg shifts (degrees)

| | | | | |
|---|---|---|---|---|
| Ω₁ₑₓₜ † | 8.1 | 0.0 | −15.0 | −34.0 |
| Ω₂ₑₓₜ † | 23.9 | 34.05 | 49.05 | 68.05 |
| ΔΩ₁ₑₓₜ ‡ | −0.21 | −0.23 | −0.38 | −0.70 |
| ΔΩ₂ₑₓₜ ‡ | +0.175 | +0.28 | +0.60 | +1.50 |

Grating slant angles, φ (degrees)

| | | | | |
|---|---|---|---|---|
| φ₀§ | 5.093 | 10.858 | 19.894 | 29.743 |
| φᵢ∥ | 5.068 | 10.803 | 19.791 | 29.582 |
| φ_{f′}¶ | 5.156 | 10.886 | 19.922 | 29.793 |
| φ_{f}** | 5.157 | 10.887 | 19.923 | 29.802 |

*Slant fringe holograms were recorded to near saturation with internal slant angles, φ, of about 5°, 10°, 20°, and 30°.
†Ω₁ₑₓₜ and Ω₂ₑₓₜ are the external signal and reference recording angles, respectively. The external interbeam angle for φ ≅ 5° was 32.0°, and for φ ≧ 10° it was 34.05°.
‡ΔΩ₁ₑₓₜ and ΔΩ₂ₑₓₜ are the deviations of the external signal and reference beam read angles from the Bragg matching condition.
§φ₀ is the internal slant angle at onset of recording where n_{0,532} = 1.5133
∥φᵢ is the internal slant angle when stable diffraction efficiency is first observed, where n_{i,532} = 1.5206.
¶φ_{f′} is the final internal slant angle after photopolymer is fully cured and is calculated by adding ΔΩ₁ₑₓₜ to Ω₁ₑₓₜ and ΔΩ₂ₑₓₜ to Ω₂ₑₓₜ and then determining the slant angle using n_{f,532} = 1.5305.
**φ_{f} is the final internal slant angle after photopolymer is fully cured and is calculated by taking the first order approximation of Δφ(as a function of Ω₁ₑₓₜ, Ω₂ₑₓₜ, ΔΩ₁ₑₓₜ, ΔΩ₂ₑₓₜ, and Δn = n_{f} − nᵢ) and then adding Δφ to φ (see Equation 5 above).

2. Grating Vector Components

In Table 4 are listed calculated values of ΔKₓ/Kₓ and ΔK_{z}/K_{z}, which are equal to the negative of the relative changes in grating period in the lateral and transverse directions, −ΔΛₓ/Λₓ and −ΔΛ_{z}, respectively, for holograms recorded to near saturation with a range of grating slant angles between about 5° and 30°. The magnitude of the physical material shrinkage along the transverse direction was on the order of 0.8% for internal grating slant angle φ≧10°, and similarly the average volume change was about 0.8%. This is in close agreement with the increase in refractive index, Δn=0.65%, that is exhibited by the recording medium during formation of holograms with high diffraction efficiency, and is less than the total increase of 1.14% (Δn₅₃₂=+0.0172) between the fluid state and the fully polymerized glass state. Cationic ring opening polymerization is not accompanied by a change in bond order, and thus the increase in refractive index that occurs during polymerization is directly related to densification of the recording material. For φ=5° the magnitude of shrinkage along the transverse direction was enlarged to 1.61% whereas the volume shrinkage, 1.31%, was slightly lower than the transverse value due to a small positive dimensional change in the lateral direction. The magnitude of ΔΛₓ is close to zero, and consequently a slight swelling in the lateral direction would be manifested as an overall expansion of Λₓ, whereas the magnitude of ΔΛ_{z} is about 10 times greater and thus largely unaffected.

The changes in internal slant angle are also listed in Table 4, as determined by using the aforementioned methods for measuring differential angle changes and refractive indices. The increases in grating slant angle occurring during hologram formation were small, and although the magnitude increased in monotonic fashion with larger slant angles for φ>5° the percentage change was less than 1%. Near unslanted plane-wave holograms (e.g. φ=−0.03°) exhibited extremely small angular deviations, ΔΩ₁_{ₑₓₜ}=−0.03° and ΔΩ₂_{ₑₓₜ}=0.003°, from the Bragg matching condition, indicating that negligible dimensional change occurred along the lateral direction under these recording conditions. The error associated with determining the physical volume change from relative changes in the components of the grating vector is, however, quite large for cases when the slant angle is less than about 3°. At small slant angles the values of K_{z,i,} which are fractional and about of factor of 10 smaller than φ, dominate determination of ΔK_{z}/K_{z,i}. Consequently, even small errors in φ, and thus Ω₁_{ₑₓₜ} and Ω₂_{ₑₓₜ}, have a significant effect on the magnitude of ΔK_{z}/K_{z,i}, as is apparent from Equations 3 and 4 above. Experimental errors in ΔΩ₁_{ₑₓₜ} and ΔΩ₂_{ₑₓₜ} are thus amplified for small grating slant angles, and in such cases contribute to large uncertainties in the final calculated value of the change in physical volume.

Values of ΔKₓ/K_{x,i}, ΔK_{z}/K_{z,i}, and ΔV/V, determined using Equations 1 and 2 above for an exact solution by adding ΔΩ₁_{ₑₓₜ} to Ω₁_{ₑₓₜ}, Δ₂_{ₑₓₜ} to Ω₂_{ₑₓₜ}, and Δn to n, to obtain Kₓ and K_{z} after recording, are also listed in Table 4. Results from the first order approximation, obtained using Equations 3 and 4 above, agree closely with results of the exact solution for holograms recorded with grating slant angles of ≦20°. The first order approximation, however, effects an overestimate for the magnitude of shrinkage along the transverse direction when the internal grating slant angleφ≅30°. Although the shrinkage is low the size of the Bragg mismatch for φ≅30° is sufficiently large to cause the difference noted. The data given in Tables 3 and 4 establish that volume holograms recorded with increasingly larger grating slant angles, and which undergo essentially equal amounts of shrinkage in the transverse direction during hologram formation, exhibit a concomitant increase in their respective angular shifts from the Bragg matching condition. Accordingly, if the amount of shrinkage is small, then the first order approximation method provides a satisfactory method for determining shrinkage, except for cases involving large grating slant angles where the Bragg mismatch may be large. Conversely, if the amount of shrinkage is moderate (i.e. several percent or larger) then the magnitude of the Bragg mismatch is necessarily large, even for small grating angles, and thus the exact solution method should be applied, except over a narrow range of small grating angles.

TABLE 4
Calculated relative changes in the grating vector along the transverse and
lateral directions, and the relative material volume change with the
assumption of homogeneity in the lateral directions, for plane-wave slant
fringe holograms recorded to near saturation

| Slant fringe | | | | |
|---|---|---|---|---|
| holograms | 5° | 10° | 20° | 30° |

First order solution

| | | | | |
|---|---|---|---|---|
| Δφ^{(°)†} | 0.089 | 0.084 | 0.133 | 0.221 |
| ΔK_{z}/K_{z,i} (%)^{‡} | 1.613 | 0.801 | 0.818 | 0.804 |
| ΔKₓ/K_{x,i} (%)^{‡} | −0.153 | 0.006 | 0.092 | −0.093 |
| −ΔV/V (%)^{§} | 1.307 | 0.813 | 1.002 | 0.617 |

Direct solution

| | | | | |
|---|---|---|---|---|
| Δφ^{(°)∥} | 0.088 | 0.083 | 0.131 | 0.211 |
| ΔK_{z}/K_{z,i} (%)^{¶} | 1.598 | 0.793 | 0.802 | 0.690 |
| ΔKₓ/K_{x,i} (%)^{¶} | −0.154 | 0.005 | 0.085 | −0.168 |
| −ΔV/V (%)** | 1.291 | 0.803 | 0.972 | 0.353 |

^{†}Δφ is determined by taking the first order approximation (see Equation 5 above) where components of K and ΔK in lateral and transverse directions are defined in Equations 1, 2, 3, and 4, and Δn = n_{f,532} − n_{i,532} as in Table 3.
^{‡}ΔK_{z}/K_{z,i} and ΔKₓ/K_{x,i} are the relative changes in the grating vector components along the transverse and lateral directions (equals the negative of the material shrinkage, −ΔΛ_{z}/Λ_{z} and −ΔΛₓ/Λₓ, in the z and x directions, independent of slant angle) and are calculated using the first order approximation from Equations 3 and 4.
^{§}−ΔV/V is determined using Equation 8 and the first order approximation for ΔK_{z}/K_{z,i} and ΔKₓ/K_{x,i} and assuming that dimensional changes in x and y are equal.

1. A process for preparing a hologram, which process comprises:
providing a holographic recording medium comprising an acid generator capable of producing an acid upon exposure to actinic radiation; a binder; a difunctional epoxide monomer or oligomer; and a polyfunctional epoxide monomer or oligomer, the difunctional and polyfunctional epoxide monomers or oligomers being capable of undergoing cationic polymerization initiated by the acid produced from the acid generator; and
passing into said medium a reference beam of coherent actinic radiation to which the acid generator is sensitive and an object beam of the same coherent actinic radiation, thereby forming within said medium an interference pattern and thereby forming a hologram within said medium.

2. A process according to claim 1 wherein at least one of the difunctional epoxide monomer or oligomer and the polyfunctional epoxide monomer or oligomer comprises a siloxane

3. A process according to claim 1 wherein at least one of the difunctional epoxide monomer or oligomer and the polyfunctional epoxide monomer or oligomer comprises an cycloalkene oxide.

4. A process according to claim 3 wherein the difunctional epoxide monomer is of the formula: 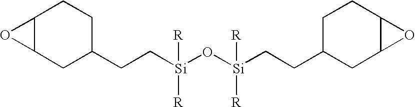
wherein each R independently is an alkyl or cycloalkyl group.

5. A process according to claim 2 wherein the polyfunctional epoxide monomer is of the formula: 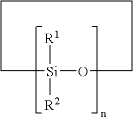
wherein each group R¹ is, independently, a monovalent substituted or unsubstituted C₁₋₁₂ alkyl, C₁₋₁₂ cycloalkyl, aralkyl or aryl group; each group R² is, independently, R¹ or a monovalent epoxy functional group having 2-10 carbon atoms, with the proviso that at least three of the groups R² are epoxy functional; and n is from 3-10.

6. A process according to claim 5 wherein the polyfunctional epoxide monomer is 1,3,5,7-tetrakis(2-(3,4-epoxycyclohexyl)ethyl)-1,3,5,7-tetramethylcyclotetrasiloxane.

7. A process according to claim 2 wherein the polyfunctional epoxide monomer is of the formula:
R³Si(OSi(R⁴)₂R⁵)₃
R³ is an OSi(R⁴)₂R⁵ grouping, or a monovalent substituted or unsubstituted C₁₋₁₂ alkyl, C₁₋₁₂ cycloalkyl, or aryl group; each group R⁴ is, independently, a monovalent substituted or unsubstituted C₁₋₁₂ alkyl, C₁₋₁₂ cycloalkyl, aralkyl or aryl group; and each group R⁵ is, independently, a monovalent epoxy functional group having 2-10 carbon atoms.

8. A process according to claim 7 wherein R³ is a methyl group or an OSi(R⁴)₂R⁵ grouping; each group R⁴ is a methyl group, and each group R⁵ is a 2-(3,4-epoxycyclohexyl)ethyl grouping.

9. A process according to claim 2 wherein the polyfunctional epoxide monomer is of the formula:
(R⁶)₃SiO[SiR⁷R⁸O]ₚ[Si(R⁷)₂O]_{q}Si(R⁶)₃
each group R⁶ is, independently, a monovalent substituted or unsubstituted C₁₋₁₂ alkyl, C₁₋₁₂ cycloalkyl, aralkyl or aryl group; each group R⁷ is, independently, a monovalent substituted or unsubstituted C₁₋₁₂ alkyl, C₁₋₁₂ cycloalkyl, aralkyl or aryl group; each group R⁸ is, independently, a monovalent epoxy functional group having 2-10 carbon atoms, and p and q are integers.

10. A process according to claim 9 wherein each group R⁶ and R⁷ is an alkyl group.

11. A process according to claim 10 wherein each group R⁸ is an 2-(3,4-epoxycyclohexyl)ethyl grouping and p and q are approximately equal.

12. A process according to claim 1 wherein the holographic medium comprises from about 0.2 to about 5 parts by weight of the difunctional epoxide monomer or oligomer per part by weight of the polyfunctional epoxide monomer or oligomer.

13. A process according to claim 1 wherein the holographic medium comprises from about 0.16 to about 5 parts by weight of the binder per total part by weight of the difunctional epoxide monomer or oligomer and the polyfunctional epoxide monomer or oligomer.

14. A process according to claim 1 wherein the volume shrinkage of the holographic medium during the formation of the hologram does not exceed about 1 per cent.

15. A holographic recording medium comprising an acid generator capable of producing an acid upon exposure to actinic radiation; a binder; a difunctional epoxide monomer or oligomer; and a polyfunctional epoxide monomer or oligomer, the difunctional and polyfunctional epoxide monomers or oligomers being capable of undergoing cationic polymerization initiated by the acid produced from the acid generator.

16. A holographic recording medium according to claim 15 wherein at least one of the difunctional epoxide monomer or oligomer and the polyfunctional epoxide monomer or oligomer comprises a siloxane

17. A holographic recording medium according to claim 15 wherein at least one of the difunctional epoxide monomer or oligomer and the polyfunctional epoxide monomer or oligomer comprises a cycloalkene oxide.

18. A holographic recording medium according to claim 17 wherein the difunctional epoxide monomer is of the formula: 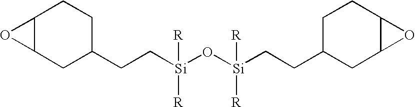
wherein each R independently is an alkyl or cycloalkyl group.

19. A holographic recording medium according to claim 16 wherein the polyfunctional epoxide monomer is of the formula: 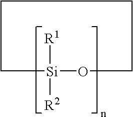
wherein each group R¹ is, independently, a monovalent substituted or unsubstituted C₁₋₁₂ alkyl, C₁₋₁₂ cycloalkyl, aralkyl or aryl group; each group R² is, independently, R¹ or a monovalent epoxy functional group having 2-10 carbon atoms, with the proviso that at least three of the groups R² are epoxy functional; and n is from 3-10.

20. A holographic recording medium according to claim 19 wherein the polyfunctional epoxide monomer is 1,3,5,7-tetrakis(2-(3,4-epoxycyclohexyl)ethyl)-1,3,5,7-tetramethylcyclotetrasiloxane.

21. A holographic recording medium according to claim 16 wherein the polyfunctional epoxide monomer is of the formula:
R³Si(OSi(R⁴)₂R⁵)₃
R³ is an OSi(R⁴)₂R⁵ grouping, or a monovalent substituted or unsubstituted C₁₋₁₂ alkyl, C₁₋₁₂ cycloalkyl, aralkyl or aryl group; each group R⁴ is, independently, a monovalent substituted or unsubstituted C₁₋₁₂ alkyl, C₁₋₁₂ cycloalkyl, aralkyl or aryl group; and each group R⁵ is, independently, a monovalent epoxy functional group having 2-10 carbon atoms.

22. A holographic recording medium according to claim 21 wherein R³ is a methyl group or an OSi(R⁴)₂R⁵ grouping; each group R⁴ is a methyl group, and each group R⁵ is a 2-(3,4-epoxycyclohexyl)ethyl grouping.

23. A holographic recording medium according to claim 16 wherein the polyfunctional epoxide monomer is of the formula:
(R⁶)₃SiO[SiR⁷R⁸O]ₚ[Si(R⁷)₂O]_{q}Si(R⁶)₃
each group R⁶ is, independently, a monovalent substituted or unsubstituted C₁₋₁₂ alkyl, C₁₋₁₂ cycloalkyl, aralkyl or aryl group; each group R⁷ is, independently, a monovalent substituted or unsubstituted C₁₋₁₂ alkyl, C₁₋₁₂ cycloalkyl, aralkyl or aryl group; each group R⁸ is, independently, a monovalent epoxy functional group having 2-10 carbon atoms, and p and q are integers.

24. A holographic recording medium according to claim 23 wherein each group R⁶ and R⁷ is an alkyl group.

25. A holographic recording medium according to claim 24 wherein each group R⁸ is an 2-(3,4-epoxycyclohexyl)ethyl grouping and p and q are approximately equal.

26. A holographic recording medium according to claim 15 comprising from about 0.2 to about 5 parts by weight of the difunctional epoxide monomer or oligomer per part by weight of the polyfunctional epoxide monomer or oligomer.

27. A holographic recording medium according to claim 15 comprising from about 0.16 to about 5 parts by weight of the binder per total part by weight of the difunctional epoxide monomer or oligomer and the polyfunctional epoxide monomer or oligomer.
